(19) United States
(12) Patent Application Publication
(10) Pub. No.: US 2006/0002162 A1
(43) Pub. Date: Jan. 5, 2006

(54) Single inductor capacitor charger

(76) Inventors: Rong-Jie Tu, Jincheng Township (TW); Yuan-Huang Cheng, Pingdung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/167,212

(22) Filed: Jun. 28, 2005

(30) Foreign Application Priority Data
Jun. 30, 2004 (TW) 093119530

(51) Int. Cl. H02M 5/20

(52) U.S. Cl. 363/166

(57) ABSTRACT

A capacitor charger comprises an inductor connected between an input voltage and an output capacitor, a taper drawn from the inductor to separate the inductor to two segments, and a switch connected to the taper, and switches the switch to produce a current to charge the output capacitor to produce an output voltage thereon.

### FIELD OF THE INVENTION

The present invention is related generally to a capacitor charger and more particularly to a single inductor capacitor charger.

### BACKGROUND OF THE INVENTION

As shown in FIG. 1, a typical capacitor charger 10 comprises a transformer 12 having a primary winding L1 and a secondary winding L2 with a turn ratio of N1:N therebetween to transform a primary current I1 to a secondary current I2. The primary winding L1 is connected between an input voltage Vin and a transistor 14 switched by a signal Vs, and the secondary winding L2 is connected between an output capacitor Co and ground GND. FIG. 2 shows a structure of the transformer 12, which comprises a ferrite core 122 with the primary and secondary windings L1 and L2 wound thereon for mutually magnetic coupling between the primary and secondary windings L1 and L2. Referring to FIGS. 1 and 2, when the transistor 14 turns on, the primary current I1 flowing through the primary winding L1 produces magnetic lines of force 124, and energy is stored in the ferrite core 122 of the transformer 12. When the transistor 14 turns off, the stored energy is released to produce the secondary current I2 flowing through the secondary winding L2 and a boost diode D1 to charge the output capacitor Co to produce an output voltage Vout.

Since two windings L1 and L2 are used in the transformer 12, the capacitor charger 10 has a large volume, and there is always a parasitic capacitor Cs present between the primary and secondary windings L1 and L2, as shown in FIG. 1. When the transistor 14 is switched, the induced voltage V_{D} on the secondary winding L2 changes violently, and the voltage and current of the parasitic capacitor Cs change accordingly, thereby inducing impact to the operation of the capacitor charger 10 to reduce its charging efficiency and performance.

Therefore, it is desired a capacitor charger having reduced parasitic capacitive effect and volume.

### SUMMARY OF THE INVENTION

One object of the present invention is to provide a novel capacitor charger.

Another object of the present invention is to provide a capacitor charger having less parasitic capacitive effect.

Still another object of the present invention is to provide a small size capacitor charger.

Yet another object of the present invention is to provide a capacitor charger having faster charging speed.

Still yet another object of the present invention is to provide a low cost capacitor charger.

A capacitor charger according to the present invention comprises a single inductor tapped to separate the inductor to two segments arranged such that the first segment is connected between an input voltage and the taper and the second segment is connected between the taper and an output capacitor, and a switch connected between the taper and ground to be switched to produce a current to charge the output capacitor to produce an output voltage.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a circuit diagram of a conventional capacitor charger;

FIG. 2 shows a structure of the transformer in FIG. 1;

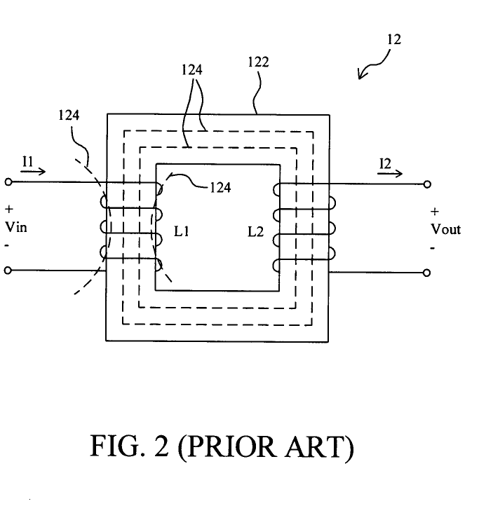

FIG. 3 shows a circuit diagram of a first embodiment according to the present invention;

FIG. 4 shows a structure of the inductor in FIG. 3;

FIG. 5 shows waveforms of various signals in the conventional capacitor charger of FIG. 1;

FIG. 6 shows waveforms of various signals in the capacitor charger of the present invention shown in FIG. 3;

FIG. 7 shows a circuit diagram of a second embodiment according to the present invention;

FIG. 8 shows a circuit diagram of a third embodiment according to the present invention;

FIG. 9 shows a circuit diagram of a fourth embodiment according to the present invention;

FIG. 10 shows a circuit diagram of a fifth embodiment according to the present invention; and

FIG. 11 shows a circuit diagram of a sixth embodiment according to the present invention.

### DETAILED DESCRIPTION OF THE INVENTION

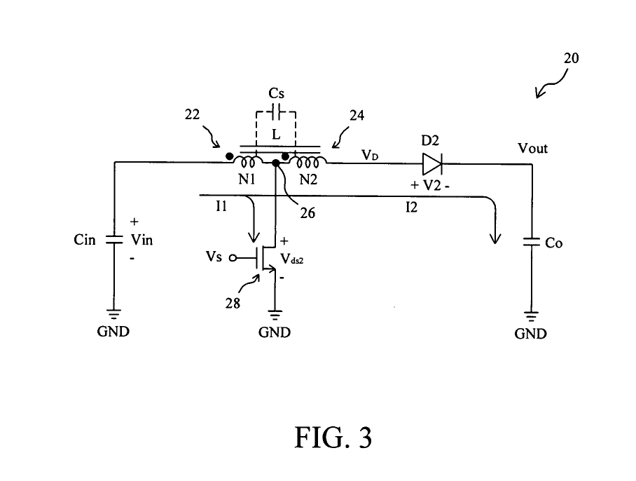

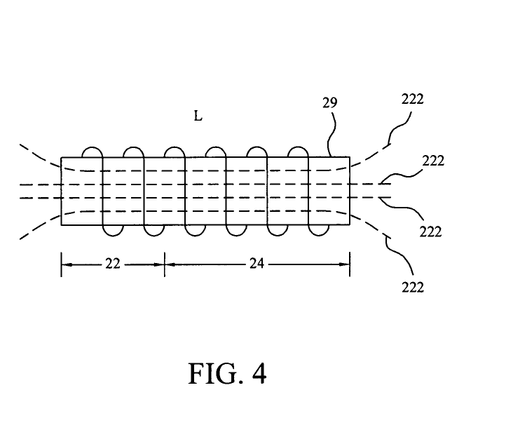

FIG. 3 shows a first embodiment according to the present invention. In a capacitor charger 20, an inductor L is connected between an input voltage Vin and a boost diode D2. The inductor L has N turns winding, and a taper 26 is drawn from the inductor L to separate the inductor L to two segments 22 and 24. The segment 22 has N1 turns winding, and therefore the other segment 24 has the turns of
N2=N−N1. [EQ-1]
A transistor 28 is connected between the taper 26 and ground GND to serve as a switch controlled by a signal Vs. FIG. 4 shows a structure of the inductor L in FIG. 3, which has a ferrite core 29 with N turns winding wound thereon. Referring to FIGS. 3 and 4, when the transistor 28 turns on, a current I1 is produced to flow through the segment 22 of the inductor L and transistor 28 to ground GND, thereby producing magnetic lines of force 222 to store energy to the ferrite core 29 of the inductor L. When the transistor 28 turns off, the stored energy is released to produce a voltage V_{D} on the segment 24 and a current I2 to charge the output capacitor Co to produce an output voltage Vout.

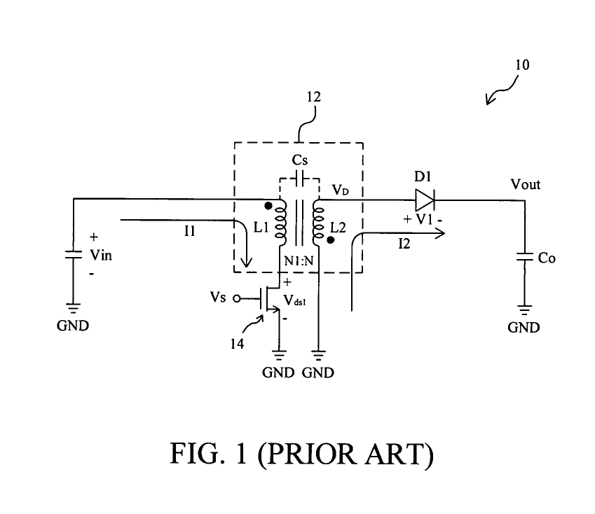

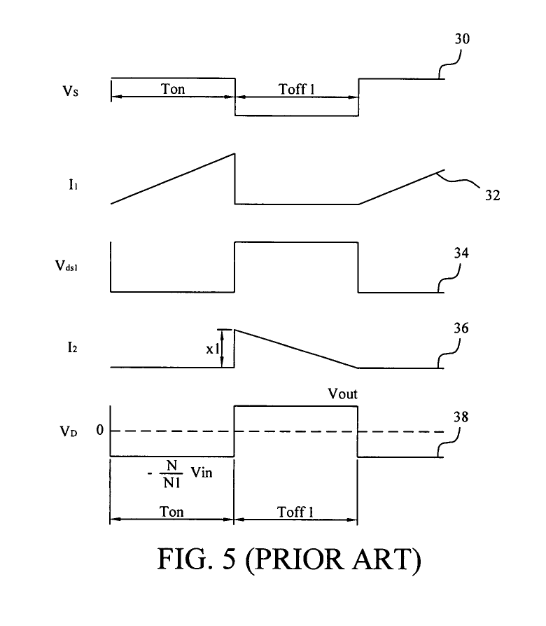

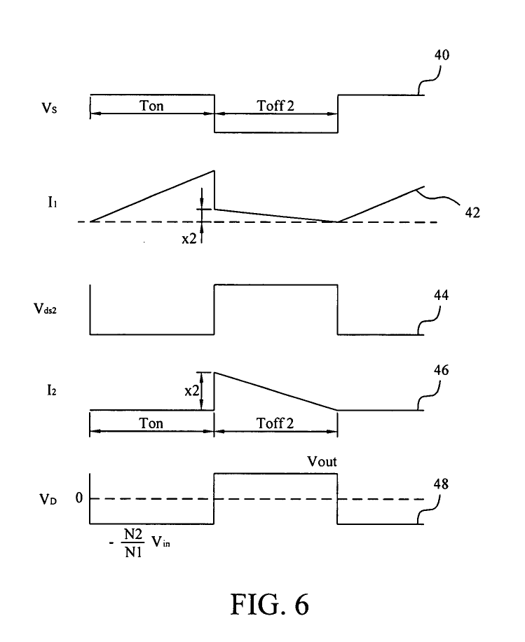

For comparison, the waveforms of various signals in the conventional capacitor charger 10 of FIG. 1 and in the capacitor charger 20 of FIG. 3 according to the present invention are shown in FIGS. 5 and 6, respectively. In FIG. 5, for the conventional capacitor charger 10, waveform 30 represents the signal Vs, waveform 32 represents the primary current I1, waveform 34 represents the voltage drop V_{ds1} across the transistor 14, waveform 36 represents the secondary current I2, and waveform 38 represents the voltage V_{D} on the winding L2. In FIG. 6, for the capacitor charger 20 of the present invention, waveform 40 represents the signal Vs, waveform 42 represents the current I1 flowing through the segment 22 of the inductor L, waveform 44 represents the voltage drop V_{ds2} across the transistor 28, waveform 46 represents the current I2 to charge the output capacitor Co, and waveform 30 represents the voltage V_{D} on the segment 24. It is assumed that the capacitor chargers 10 and 20 use the same property and type of ferrite cores and windings for the transformer 12 and inductor L to produce the same output voltage Vout from the same input voltage Vin. Referring to FIGS. 1, 3, 5 and 6, the transistors 14 and 28 have the same on-time Ton, and therefore the currents I1 of the chargers 10 and 20 have the same maximum value. In other words, the ferrite cores 122 and 29 will store the same magnetic energy, resulting in the currents I2 of the chargers 10 and 20 to have the maximum value
X1=X2=X, [EQ-2]
where X1 is the maximum value of the current I2 in the charger 10, and X2 is the maximum value of the current I2 in the charger 20.

It is known to those skilled ones in the art that the charger 10 has the charging time, i.e., the off-time of the transistor 14, of

$$Toff1 = \frac{{N}^{2} \times Vin}{{N1}^{2} \times Vout} , \qquad [ EQ \text{-} 3 ]$$

and the charger 20 has the charging time, i.e., the off-time of the transistor 28, of

$$Toff2 = \frac{{N}^{2} \times Vin}{{N1}^{2} \times ( Vout - Vin )} . \qquad [ EQ \text{-} 4 ]$$

By comparing the equations EQ-3 and EQ-4, it is shown that the charging time Toff2 of the charger 20 is larger than the charging time Toff1 of the charger 10. Namely, the charger 10 will have more switching times for the transistor 14 than that for the transistor 28 of the charger 20. Therefore, the charger 20 of the present invention has reduced switching loss and improved efficiency.

Moreover, the charger 10 has the average charging current

$$Iavg1 = \frac{X1 \times \frac{Toff1}{2}}{Ton + Toff1} = \frac{X1 \times Toff1}{2 ( Ton + Toff1 )} , \qquad [ EQ \text{-} 5 ]$$

while the charger 20 has the average charging current

$$Iavg2 = \frac{X2 \times \frac{Toff2}{2}}{Ton + Toff2} = \frac{X2 \times Toff2}{2 ( Ton + Toff2 )} . \qquad [ EQ \text{-} 6 ]$$

From the equations EQ-2, EQ-3, and EQ-5, it is obtained

$$Iavg1 = \frac{X \times \frac{{N}^{2} \times Vin}{{N1}^{2} \times Vout}}{2 ( Ton + \frac{{N}^{2} \times Vin}{{N1}^{2} \times Vout} )} = \frac{X \times {N}^{2} \times Vin}{2 ( Ton \times {N1}^{2} \times Vout + {N}^{2} \times Vin )} , \qquad [ EQ \text{-} 7 ]$$

and from the equations EQ-2, EQ-4, and EQ-6, it is obtained

$$Iavg2 = \frac{X \times \frac{{N}^{2} \times Vin}{{N1}^{2} \times ( Vout - Vin )}}{2 ( Ton + \frac{{N}^{2} \times Vin}{{N1}^{2} \times ( Vout - Vin )} )} = \frac{X \times {N}^{2} \times Vin}{2 [ Ton \times {N1}^{2} \times ( Vout - Vin ) + {N}^{2} \times Vin ]} . \qquad [ EQ \text{-} 8 ]$$

The equations EQ-7 and EQ-8 show that
Iavg2>Iavg1. [EQ-9]
Therefore, the charger 20 of the present invention has faster charging speed than the conventional charger 10.

On the other hand, when the transistors 14 and 28 turn off, the transistor 14 of the conventional charger 10 will withstand the voltage drop

$${V}_{ds1} = \frac{N1 \times Vout + N \times Vin}{N} , \qquad [ EQ \text{-} 10 ]$$

and the transistor 28 of the charger 20 according to the present invention will withstand the voltage drop

$${V}_{ds2} = \frac{N1 \times Vout + N2 \times Vin}{N} , \qquad [ EQ \text{-} 11 ]$$

which shows that V_{ds2} is smaller than V_{ds1}. Therefore, the voltage required for the transistor 28 of the charger 20 in the present invention to be capable of withstanding is smaller, and the cost of the transistor 28 is less. When the transistors 14 and 28 turn on, the boost diode D1 of the conventional charger 10 has the voltage drop

$$V1 = Vout + \frac{N}{N1} Vin , \qquad [ EQ \text{-} 12 ]$$

and the boost diode D2 of the charger 20 according to the present invention has the voltage drop

$$V2 = Vout + \frac{N2}{N1} Vin , \qquad [ EQ \text{-} 13 ]$$

which shows that V2 is smaller than V1. Therefore, the voltage required for the boost diode D2 of the charger 20 in the present invention to be capable of withstanding is smaller, and the cost of the boost diode D2 is less. From FIGS. 1 and 3, it is also shown that the inductor L of the charger 20 is less N1 turns than that of the conventional charger 10, and therefore the charger 20 will have a smaller volume. Even a parasitic capacitor Cs is present between the segments 22 and 24 of the inductor L in the charger 20, the capacitive effect induced therefrom is reduced, since the segments 22 and 24 are connected to each other and will have zero voltage drop therebetween.

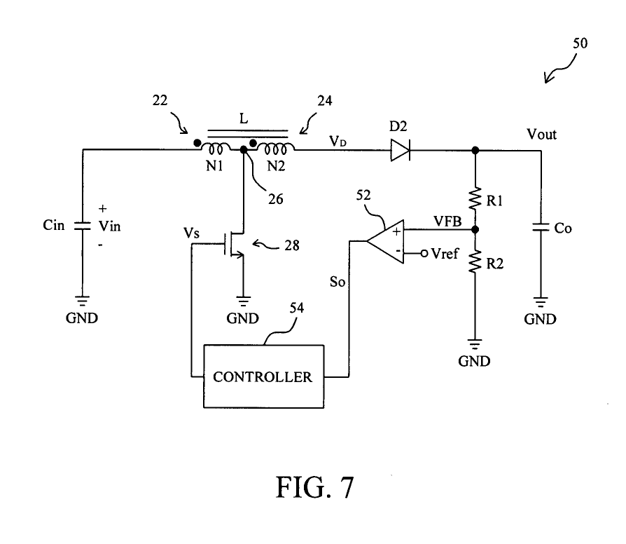

FIG. 7 shows a second embodiment according to the present invention. This capacitor charger 50 has a basic scheme the same as that of the capacitor charger 20 shown in FIG. 3, but is introduced additionally with means for the control of the output voltage Vout, in which two resistors R1 and R2 are connected between the output voltage Vout and ground GND to serve as a sensor to produce a sense signal VFB by dividing the output voltage Vout, as in the following relationship

$$Vout = VFB \times \frac{R1 + R2}{R2} . \qquad [ EQ \text{-} 14 ]$$

Since the sense signal VFB is proportional to the output voltage Vout, it could easily monitor the output voltage Vout from the sense signal VFB. Once the output voltage Vout is sensed equal to or larger than a predetermined threshold such that the sense signal is equal to or larger than the reference Vref provided for the comparator 52, a comparison signal So produced by a comparator 52 will signal a controller 54 to stop charging the output capacitor Co.

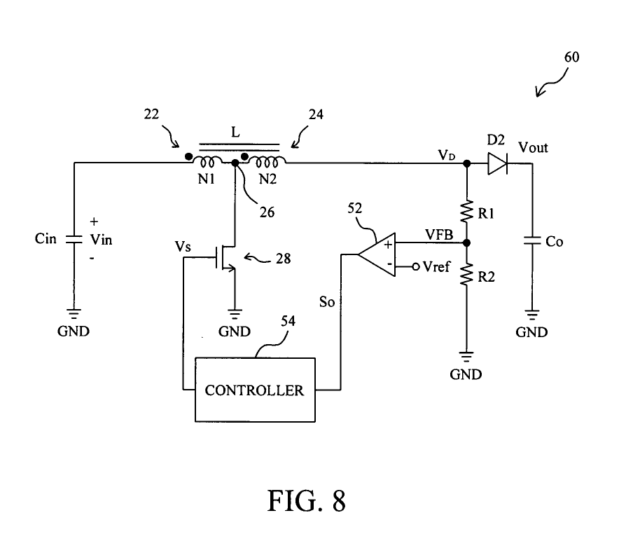

The capacitor charger 50 shown in FIG. 7 is modified to be a third embodiment as shown in FIG. 8. Hereof a capacitor charger 60 has the sensor composed of the resistors R1 and R2 connected to the inductor L such that the boost diode D2 is arranged between the resistors R1 and R2 and output capacitor Co, by which the output capacitor Co is prevented from a leakage current inversely flowing therefrom to the resistors R1 and R2 during the off-time of the transistor 28.

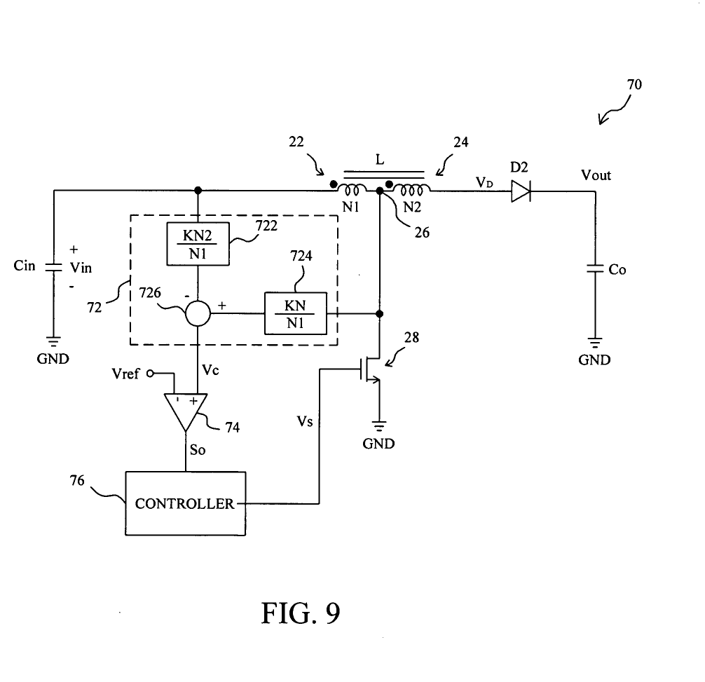

FIG. 9 shows a fourth embodiment according to the present invention. In a capacitor charger 70 having a basic scheme the same as that of the capacitor charger 20 shown in FIG. 3, a sensor 72 is provided to sense the input voltage Vin and the tapped voltage V_{ds2} on the taper 26 for the control of the output voltage Vout. In the sensor 72, the input voltage Vin and tapped voltage V_{ds2} are multiplied by two coefficients at two multipliers 722 and 724, respectively, and combined by a summing circuit 726 to produce a sense signal

$$Vc = \frac{K \times N}{N1} {V}_{ds2} - \frac{K \times N2}{N1} Vin = \frac{K}{N1} ( N \times {V}_{ds2} - N2 \times Vin ) , \qquad [ EQ \text{-} 15 ]$$

where K is a constant. It is known to those skilled ones in the art that the taper 26 will has the tapped voltage

$${V}_{ds2} = \frac{N1 \times Vout + N2 \times Vin}{N} , \qquad [ EQ \text{-} 16 ]$$

and by substituting the equation EQ-16 to the equation EQ-15, it is obtained
Vc=K×Vout. [EQ-17]
Since the sense signal Vc is proportional to the output voltage Vout, it may be used to monitor the output voltage Vout. The sense signal Vc is compared with a reference Vref by a comparator 74 to produce a comparison signal So for a controller 76 to switch the transistor 28. Once the output voltage Vout is sensed equal to or larger than a predetermined threshold such that the sense signal is equal to or larger than the reference Vref provided for the comparator 52, the comparison signal So produced by the comparator 52 will signal the controller 54 to stop charging the output capacitor Co.

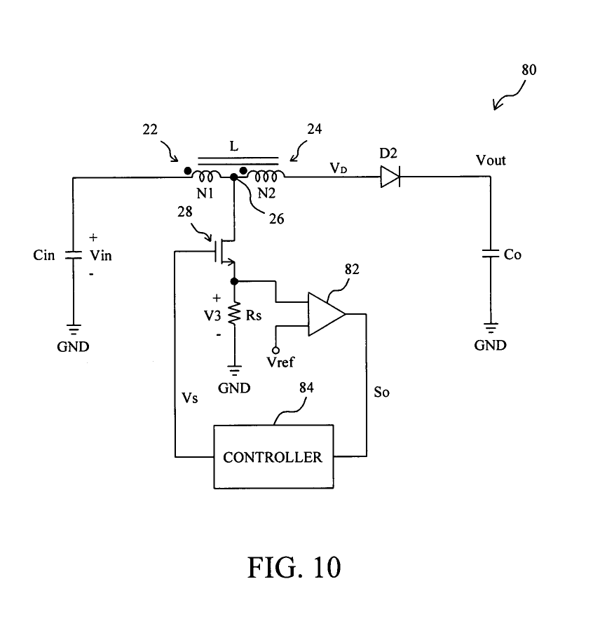

FIG. 10 shows a fifth embodiment according to the present invention. In a capacitor charger 80 having a basic scheme the same as that of the capacitor charger 20 shown in FIG. 3, a sense resistor Rs is connected in series to the transistor 28 such that the current I1 flowing through the segment 22 of the inductor L flows through the sense resistor Rs to produce a voltage drop V3 across the sense resistor Rs, and a comparator 82 compares the voltage V3 with a reference Vref to produce a comparison signal So for a controller 84 to switch the transistor 28. Alternatively, the conductive resistance of the transistor 28 may be used for the sense resistor, and the voltage drop across the transistor 28 is compared with the reference Vref by the comparator 82 to produce the comparison signal So.

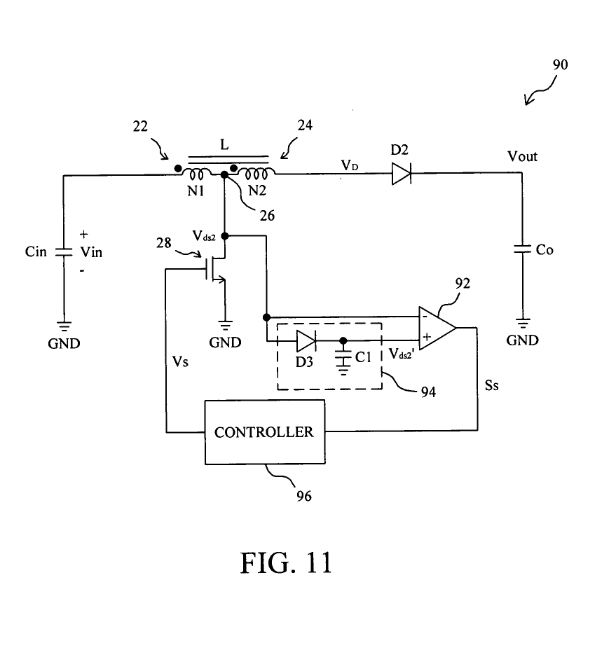

FIG. 11 shows a sixth embodiment according to the present invention. In a capacitor charger 90 having a basic scheme the same as that of the capacitor charger 20 shown in FIG. 3, a comparator 92 and a sample and hold circuit 94 constitute a sensor to sense if the current I2 flows during the off-time of the transistor 28. It is known to those skilled ones in the art that the tapped voltage V_{ds2} follows the equation EQ-16 when the current I2 flows during the off-time of the transistor 28, and drops down to the input voltage Vin after the current I2 stops flowing. When the transistor 28 turns off and the current I2 flows, the sample and hold circuit 94 samples and holds the tapped voltage V_{ds2} to produce a sample signal V_{ds2}′. The tapped voltage V_{ds2} and sample signal V_{ds2}′ are compared by the comparator 92. When the tapped voltage V_{ds2} is smaller than the sample signal V_{ds2}′, the comparison signal Ss produced by the comparator 92 will signal a controller 96 to turn on the transistor 28.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A capacitor charger comprising:
an output capacitor;
an inductor connected between an input voltage and the output capacitor;
a taper drawn from the inductor to separate the inductor to two segments; and
a switch connected to the taper for being switched to produce a current to charge the output capacitor to produce an output voltage.

2. The capacitor charger of claim 1, wherein the switch comprises a transistor.

3. The capacitor charger of claim 1, further comprising:
a comparator for comparing the output voltage with a reference to produce a comparison signal; and
a controller in response to the comparison signal for switching the switch.

4. The capacitor charger of claim 1, further comprising:
a sensor for sensing the input voltage and a tapped voltage on the taper to produce a sense signal;
a comparator for comparing the sense signal with a reference to produce a comparison signal; and
a controller in response to the comparison signal for switching the switch.

5. The capacitor charger of claim 4, wherein the sensor comprises:
a first multiplier for multiplying the input voltage by a first coefficient to produce a first signal;
a second multiplier for multiplying the tapped voltage by a second coefficient to produce a second signal; and
a summing circuit for combing the first and second signals to produce the sense signal.

6. The capacitor charger of claim 1, further comprising:
a sense resistor connected to the switch;
a comparator for comparing a voltage drop across the sense resistor with a reference to produce a comparison signal; and
a controller in response to the comparison signal for switching the switch.

7. The capacitor charger of claim 1, further comprising:
a sensor for sensing a tapped voltage on the taper to produce a sense signal; and
a controller in response to the sense signal for switching the switch.

8. The capacitor charger of claim 7, wherein the sensor comprises:
a sample and hold circuit for sampling and holding the tapped voltage to produce a sample signal; and
a comparator for comparing the tapped voltage with the sample signal to produce the sense signal.
